(19) United States
(12) Patent Application Publication
(10) Pub. No.: US 2026/0296838 A1
(43) Pub. Date: Oct. 1, 2026

(54) METHODS AND SYSTEM FOR LOAD LIFTING AND TRANSPORT

(71) Applicants: Kyle Wagner, Redwood City, CA (US); David Rivera, Austin, TX (US); Brandon McKee, Austin, TX (US); Emory Sweeney, Austin, TX (US)

(72) Inventors: Kyle Wagner, Redwood City, CA (US); David Rivera, Austin, TX (US); Brandon McKee, Austin, TX (US); Emory Sweeney, Austin, TX (US)

(21) Appl. No.: 19/576,867

(22) Filed: Mar. 24, 2026

Related U.S. Application Data
(60) Provisional application No. 63/777,869, filed on Mar. 26, 2025.

(51) Int. Cl. B66C 1/12

(52) U.S. Cl. CPC B66C 1/12

(57) ABSTRACT

The present disclosure relates to lifting and hoisting devices and systems for one or more objects to be lifted and transported. In some embodiments, the systems comprise rigid members that are operable to lift objects while maintaining the objects in a desired spaced apart arrangement. Supporting and connecting elements are provided that are suited for lifting relatively heavy objects that may be devoid of dedicated rigid contact points for lifting. In various embodiments a system is provided and is disposable into and out of an expanded state for operation and a folded state for storage and transport.

### CROSS REFERENCE

This U.S. Non-Provisional Patent Application claims the benefit of U.S. Provisional Application Ser. No. 63/777,869, filed on Mar. 26, 2025, the entire disclosure of which is hereby incorporated by reference.

### FIELD

The present disclosure relates generally to lifting devices, systems, and related methods of use. Certain embodiments of the present disclosure are directed to systems and methods for load supporting and lifting devices that are operable to support one or more objects simultaneously.

### BACKGROUND

Various lifting, hoisting and support devices are known for handling objects and structures. Hook and gantry systems with associated support structures, for example, are widely used across various fields.

Certain objects, however, are less suitable for overhead lifting than others. Metal shipping containers, for example, comprise a structural integrity that is suitable for lifting with various devices, systems and methods. Such rigid objects may, for example, receive a lifting force at various points on the object such that the object is moveable with a forklift-style device and/or an overhead system (e.g. a crane or gantry) attached at various locations on the object. In contrast, other devices comprise more limitations with respect to how lifting forces are applied. As a non-limiting example, temporary restrooms generally comprise a predominantly plastic structure suitable for providing shelter and privacy but not necessarily suitable for lifting given the object's relatively large mass. Such objects, however, also require frequent lifting, moving and relocating. It is also often efficient and desirable to handle or manipulate a plurality of such objects during a single operation. However, conventional lifting solutions are generally designed to lift one object at a time.

### SUMMARY

Accordingly, there is a long-felt and unmet need for lifting devices, systems and methods that comprise relatively high weight-bearing capacity and which can lift multiple objects at the same time. There has further been a long-felt and unmet need for a crane lifting system that is capable of lifting objects while supporting said objects from preferred locations.

It is one aspect of various embodiments of the present disclosure to provide a lifting system that is configured to lift a plurality of objects simultaneously. In some embodiments, lifting systems are provided that comprise at least one lifting frame configured to receive and lift one or more objects.

In some embodiments, lifting systems are provided that comprise at least one spreader bar comprising one or more anchor points to be connected to objects for lifting. The spreader bar is contemplated as comprising a central lifting point for receiving (for example) a crane hook, a gantry hook, or another lifting system component.

In some embodiments, lifting frames are provided that comprise one or more rotatable or foldable features such that the frame can be converted from a first position to a second position. The first position is contemplated as comprising a position of use or lifting. The second position is contemplated as comprising a folded or compressed position wherein the system is suitable for non-use or storage.

Another aspect of various embodiments of the present disclosure is the capability of receiving and lifting objects of different shapes and sizes. In some embodiments, a lifting frame comprises a base and main frame, where the base and the main frame define a partially-open space to receive objects. The partially-open arrangement of lifting frames of the present disclosure can receive objects constructed of various heights, depths, and/or widths.

As mentioned, in some embodiments, the supporting members are optional and detachable. To expand the lifting space in a longitudinal direction, operators may detach the supporting members to allow the lifting framework like a forklift with little dimensional restrain in the longitudinal direction.

It is another aspect of the present invention to lift and support heavy objects. In some embodiments, a single lifting apparatus comprises two lifting platforms. The lifting apparatus may comprise, for example, a loading capacity of 2,000 pounds, with each platform constructed to be capable of lifting 1,000 pound objects. In some embodiments, certain types of materials are selected to construct the lifting apparatus. For example, some lifting apparatuses are constructed with steel tubes with per ASTM A500 Grade B, and steel plates and angles with per ASTM A36.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification and claims are to be understood as being modified in all instances by the term “about”.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The term “a” or “an” entity, as used herein, refers to one or more of that entity. As such, the terms “a” (or “an”), “one or more,” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

It is to be appreciated that any feature described herein can be claimed in combination with any other feature(s) as described herein, regardless of whether the features come from the same described embodiment.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein.

The accompanying drawings, which are incorporated in and constitute a part of the specification, illustrate embodiments of the invention and together with the general description of the invention given above and the detailed description of the drawings given below, serve to explain the principles of certain embodiment of the present disclosure.

FIG. 1A is a perspective view of an embodiment of a lifting frame in an expanded state according to one embodiment of the present disclosure.

FIG. 1B is a left view of the embodiment of FIG. 1A.

FIG. 1C is a perspective view of the embodiment of FIG. 1A in a folded state.

FIG. 1D is a perspective view of the embodiment of FIG. 1A in a deflected.

FIG. 2 illustrates a lifting system with multiple connected lifting frames.

FIG. 3A is a perspective view of a component of a lifting member according to one embodiment of the present disclosure.

FIG. 3B is an exploded perspective view of the embodiment of FIG. 3A.

FIG. 3C is a perspective view of a plurality of components contemplated for use with embodiments of the present disclosure.

FIG. 4A is a perspective view of a plurality of items and a lifting member according to an embodiment of the present disclosure.

FIG. 4B is a top plan view of lifting components and different configurations of items associated with the components.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

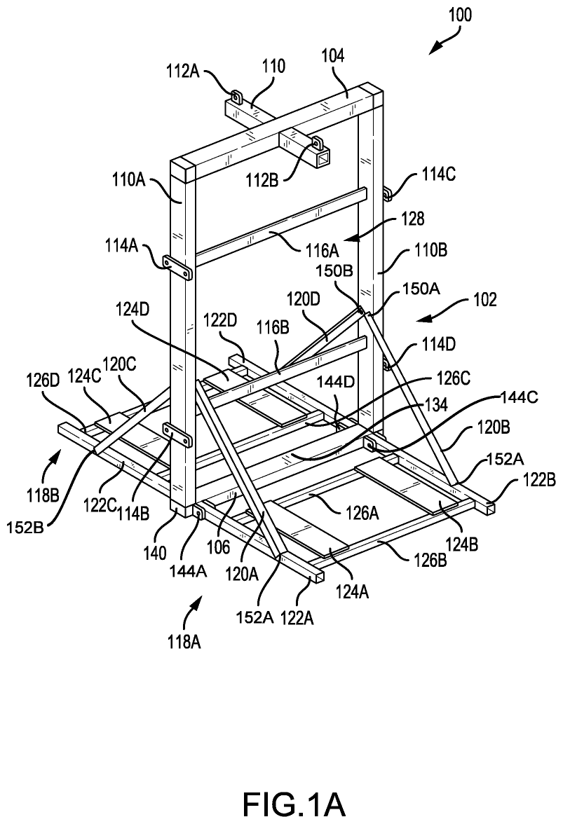

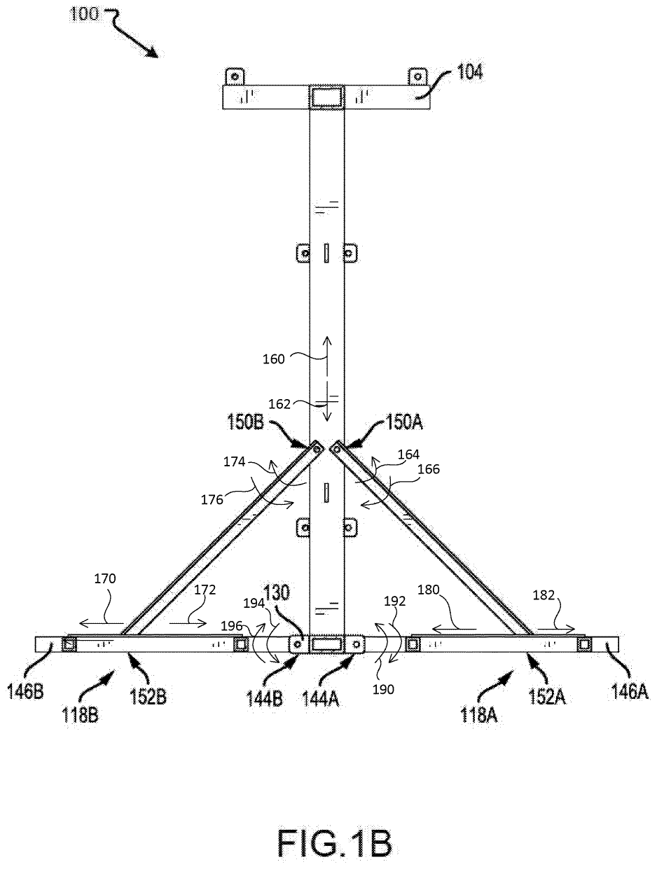

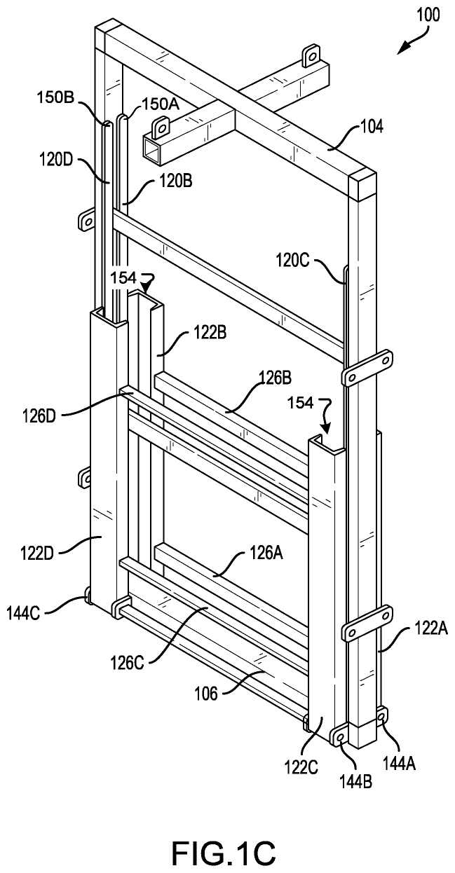

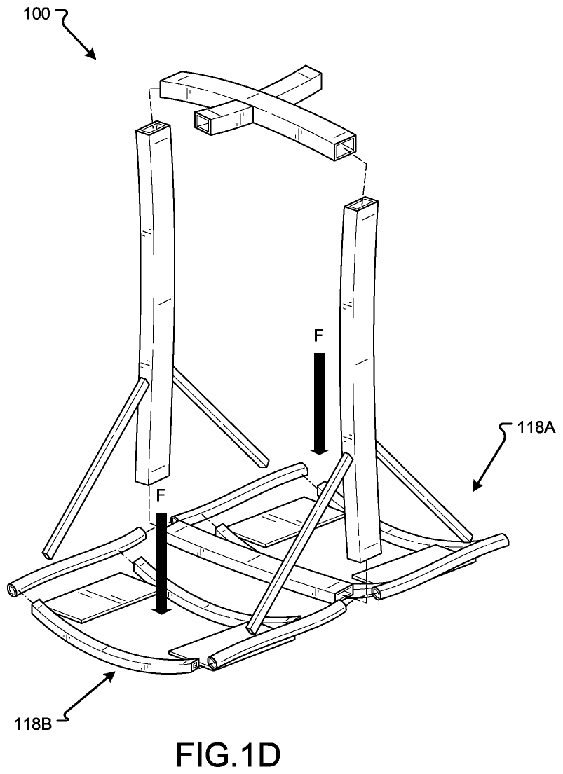

FIGS. 1A-1D depict various embodiments of a lifting device 100 according to one or more embodiments of the present disclosure. As shown in FIG. 1A, in various embodiments the lifting device 100 comprises a main frame 102 and one or more lifting platforms 118 operable to support the weight of one or more objects. In various embodiments, and as shown in FIG. 1A, two lifting platforms are provided opposite to each other in a lateral dimension. One or more support members 120 are provided to support the weight of the lifting platform(s) and associated objects.

The lifting device 100 is disposable into and out of an expanded state associated for periods of operation and/or use, and a folded state for periods of non-use, for example, for storage and/or transport. In various embodiments, the lifting platforms 118 are pivotally attached to the frame 102 via a variety of mechanisms, including without limitation, hinged connections, brackets, connectors, pins, etc. In various embodiments, the lifting platforms 118A and 118B are foldable towards the frame 102 respectively in directions 190 and 196 (shown in FIG. 1B) to dispose the lifting device 100 into the folded state. The lifting platforms 118A and/or 118B are expandable or otherwise movable away from the frame 102, respectively in directions 192 and 194, to a predetermined angular position that dispose the platforms 118A and/or 118B into the expanded state. In various embodiments, the predetermined angular position of the lifting platform 118A and/or 118B is approximately transverse, i.e., about 90 degrees, with respect to the frame 102. However, this is not necessarily limiting as the angular position of the lifting platform 118A and/or 118B with respect to the frame 102 can vary in other embodiments. In some embodiments, however, the supporting members 120 are integrally formed with the frame 102 and the base 118 during manufacturing, including, via one or more processes to fabricate the pillars and the upper and lower members from a single piece of fabrication stock or material.

FIGS. 1A and 1B show embodiments of a lifting device 100 in an expanded state, whereas FIG. 1C illustrates an embodiment of the lifting device 100 in the folded state. In certain embodiments, the main frame member 102 comprises an upper member 104, a lower member 106, and two vertical members 110A and 110B, which collectively define a rectangular opening 128. For example, in some embodiments the pillars 110 are affixed to the upper member 104 and to the lower member 106 via one or more joining processes (e.g., welding, or the like) and/or via one or more connectors, including fasteners, bolts, screws, etc. It is noted, however, that in other embodiments the pillars or vertical supports 110 are integrally formed with the upper and lower members 104 and 106 during manufacturing, e.g., via one or more processes to fabricate the vertical supports 100 or pillars and the upper and lower members 106 and 104 from a single piece of fabrication stock or material.

In various embodiments, the main frame member 102 also includes one or more dividing members 116 within the opening 128 and located between the upper member 104 and the lower member 106 in a vertical direction. The dividing members 116 are constructed to separate two loading objects at each side of the main frame 102 preventing the loading objects from colliding and sliding through the opening. In the non-limiting embodiment, the dividing members 116 are constructed as metal plates. It some other embodiments, the dividing members are constructed in other shapes. In one or more embodiments, the dividing members 116 include a first dividing member 116A and a second dividing member 116B. However, the number and/or orientation of the dividing members may vary in different embodiments.

In various embodiments, the one or more lifting platforms 118 include a first lifting platform and 118A and a second lifting platform 118B, each one comprising two sidebars. For example, in various embodiments the first base 118A has a first sidebar 122A and a second sidebar 122B. In one or more embodiments, the sidebars 122A and/or 122B extend from the main frame 102, laterally from the lower member 106. In various embodiments, the first sidebar 122A is spaced apart from the second sidebar 122B in a longitudinal direction, e.g., with the first and second sidebars 122A and 122B being substantially parallel to each other. In some embodiments, including as shown in FIG. 1B, hinged connections 144 interconnect the lifting platforms 118A and/or 118B to the lower member 106. In various embodiments, the hinged connections 144 allow the lifting platforms 118A and/or 188B to pivotally move with respect to the lower member 106, respectively in directions 190 and 192, and/or 194 and 196, such that the lifting platforms 118 can be folded and/or expanded to dispose the lifting device 100 into and out of the folded state and the expanded state. However, in other embodiments, the lifting platforms 118A and/or 118B comprise other geometries and/or configurations.

FIG. 1B is a side view of one or more embodiments of a lifting device 100 in the expanded state. In some embodiments, each lifting platform 118A and/or 118B has a maximum bearing load of approximately 1,000 lbs. FIG. 1D illustrates an approximate (not to scale) deflected shape of the various components of the lifting device 100 when a 1,000 lb. load or a comparable load is applied to each platform 118A and/to 118B of the lifting device 100.

In one or more embodiments of the lifting device 100, the supporting member 120 is operable to pivot or more about a first end 150 and/or a second end 152 to dispose the lifting platforms 118A and/or 118B into and out of the expanded state and the folded state. As shown at least in FIG. 1B, in various embodiments, the first end 150 of the supporting member 120 is attached to a corresponding lifting beam or vertical support 110 of the main frame 102. In various embodiments, the second end 152, which is opposite to the first end 150, is supported by a corresponding sidebar 122 of the lifting platform 118. In some embodiments, in the expanded state the first end 150 of the supporting member 120 is connected to a corresponding vertical support 110 and the second end 152 is connected to a corresponding sidebar 122 when in the expanded state, such that the supporting member 120 is diagonal to both the lifting platform 118 and the frame 102.

In at least one embodiment, the first end 150 is fixed at a vertical position along the height or the vertical support 110. In at least one embodiment, the first end 150 is pivotally connected to the vertical support 110 such that the supporting member(s) 120 may be pivotally moved in directions 164 and/or 166, and/or in directions 174 and/or 176, to dispose the lifting device 100, i.e., the platforms 118 and the supporting member 120, into and out of the folded state and the expanded state. In such embodiments, the supporting member(s) 120 may be horizontally translated along the length of a corresponding sidebar 122, i.e., in directions 170, 172, 180 and/or 182 to a predetermined stop point. In various embodiments, a stop point of the supporting member 120 is reached when the platform 118, and consequently a corresponding sidebar 122, is moved into the expanded state, i.e., into a position of the sidebar 122 that is substantially transverse to the vertical support 110, for example, as shown in the illustrative embodiments of FIGS. 1B and 1A. In one or more embodiments, a stop point of the sidebar 122 is enabled by one or more of a groove, raised protrusion, a cavity, and/or or another mechanism, such as bolts, brackets, pins, etc., which can fix the second end 152 to the sidebar 122 when the lifting device 100 is disposed into the expanded state. For example, in one or more embodiments, a sidebar 122 comprises a cavity 154 operable to receive a portion of a corresponding supporting member 120 to prevent a potential collision with another component of the device 100, e.g., lifting platform 118, the frame 102, and the supporting member 120.

In some embodiments, the lifting device 100 comprises a hinged mechanism 144A and/or 144B that prevents a further rotation of the lifting platform 188 and sidebar 122 in directions 192 and/or 194 after reaching an intended rotational position that is associated with the expanded state of the lifting device 100. For example, in one or more embodiments, the hinged mechanism 144A and/or 144B is provided with an underside plate or support that prevents a further rotation of the platform 188 beyond an intended rotational position thereby enabling a substantially transverse orientation of the sidebar 122 relative to the vertical support 110. In at least one embodiment, the lifting device 100 comprises a combination of a hinge 144 with an underside support as well as fixating mechanism that secures the second end 152 of the supporting member 120 at an intended horizontal position within the length of a corresponding sidebar 122.

In one or more embodiments, the supporting member 120 is pivotally connected to the vertical support 110, such that it may be rotated in directions 164 and/or 174, and/or in directions to dispose the lifting device 100 into the folded state, and/or in directions 166 and/or 176 to dispose the lifting device 100 into the expanded state. As such, in one or more embodiments the second end 152 of the supporting member may be moved from a position where it is supported by a sidebar 122, i.e., in the expanded state as shown in FIGS. 1A and 1B, to a position where the supporting member 120 as well as the sidebar 122 are substantially parallel to the vertical support 110, i.e., in the folded state as shown in FIG. 1C. Said differently, in various embodiments, the second end 152 may be released from the lifting platform 118 to permit transitioning between the expanded state into the folded state. In such embodiments, to rotate the support member 120 the second end 152 should not be fixed to a corresponding sidebar 122. In various embodiments, when the lifting device 100 is in the folded state, the supporting members 120 are in contact with the inner surfaces of the pillar or vertical support member 110.

The foregoing embodiments illustrate possible mechanisms to dispose the lifting device 100 between the expanded state and the folded state. However, such mechanisms are not necessarily limiting as other alternative embodiments of the device 100 contemplate other mechanisms of operation. In various alternative embodiments, when in the folded state, both the first and second ends 150 and 152 are removable respectively from the main frame 102 and the lifting platform 118, e.g., such that they may be handled and/or stored separately. However, in other embodiments, when in the folded state, the first end 150 of the supporting member 120 is removable from the frame 102 and the second end 152 of the supporting member 120 remains attached to the lifting platform 118.

Various alternative embodiments of the device 100 contemplate that the first end 150 of the supporting member 120 be translatable about the length of a vertical support 110 to dispose the device 100 into and out of the expanded state and the folded state. In such alternative embodiments, the second end 152 of the support member 120 is pivotally connected to a corresponding sidebar 122 and is fixed at an intended horizontal position along the length of the sidebar 122. In such embodiments, the first end 150 of the supporting member 120 is translatable along the length of the vertical support 110 between an intended vertical position associated with the expanded state, e.g., as shown in FIGS. 1A and 1B, to position associated with the folded state where the first end 150 are between the sidebar 122 and the upper member 104, e.g., as shown in FIG. 1C. For example, in some embodiments, the vertical support 110 comprises a track (not shown) or channel along its length, e.g., an elongated slot, and the vertical support 120 is provided with a connector or pin that retains the first end 150 of the support member 120 to the track of the vertical support 110. Such a mechanism enables a vertical translation of the first end 150 of the supporting member 120, e.g., in directions 160 and/or 162 to dispose the lifting device 100 into and out of the expanded state and the folded state. In some embodiments, the first end 150 is not contemplated to shift or translate horizontally when transitioning between states.

In a further alternative embodiment (not shown) the lifting device or apparatus 100 comprises a collapsible supporting member 120. In such embodiments, the lifting device 100 comprises a supporting member 120 comprising to segments connected to one another and collectively defining an overall length of the supporting member 120. In such embodiments, the two segments of the supporting member 120 are joined at an intersection, e.g., a hinged or pivotal connection operable to collapse inward, i.e., toward the intersection of a vertical support 110 and a lifting platform 118. In such embodiments, the first end 150 and second end 152 of the supporting member 120 are pivotally connected, respectively to the vertical support 110 and a sidebar 122 of the lifting platform 118. As such, when the lifting device 100 is in the expanded state the segments of the supporting member 120 collectively define a straight or substantially straight elongated shape such that the supporting member is diagonal to both the vertical support 110 and the lifting platform 118 and sidebar 122. When the lifting device is in the folded state, the two segments of the supporting member 120 are collapsed and are at least partially or fully in confronting relation to one another in a vertical dimension.

FIG. 1D illustrates the expanded and deflected condition of the lifting apparatus 100. In various embodiments, the lifting apparatus 100 has a deflection of about 0.093 inches per inch of length when loaded with approximately 1000 lbs. on each of the lifting platforms 118. It will be recognized, however, that features of the present disclosure may be modified (e.g. scaled or provided with different material) to alter the overall strength capacity of the device(s).

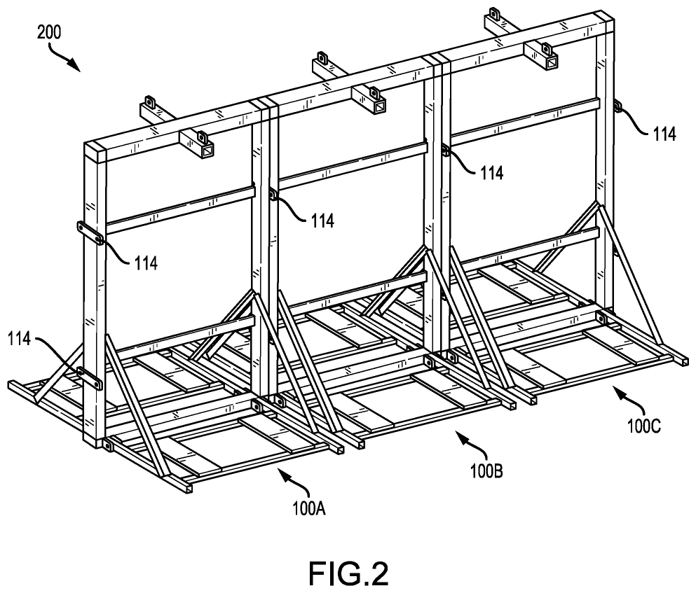

FIG. 2 illustrates a lifting system 200 comprising a plurality of lifting devices 100A, 100B, 100C. In the depicted embodiment, the lifting system 200 is capable of carrying, hoisting, and/or bearing up to six objects. In one or more embodiments, each lifting device 100 has one or more attachment mechanism 114 placed at the exterior of each lifting beam 110. In various embodiments, an attachment mechanism 114 is welded to the pillar 110 of the frame 102 and/or is configured to also attach to a lifting beam of an adjacent lifting apparatus, which allows for multiple devices to be attached together. In various embodiments, each pillar 110 of the lifting apparatus 100 has two attachment mechanisms 114 parallel to and spaced from each other in the vertical dimension. However, the number of the attaching mechanism 114 varies in other embodiments.

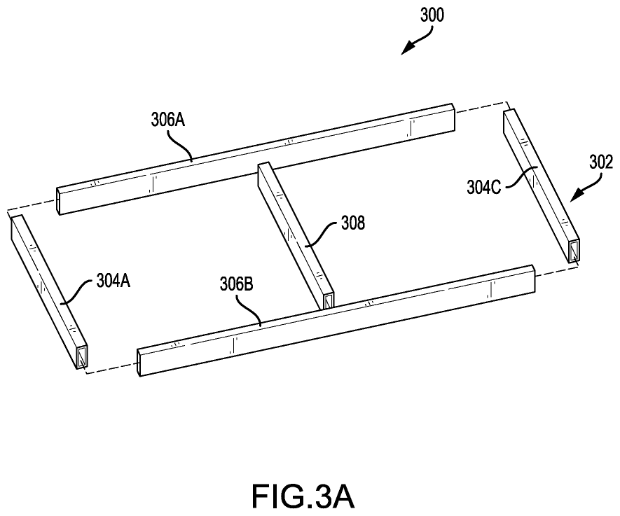

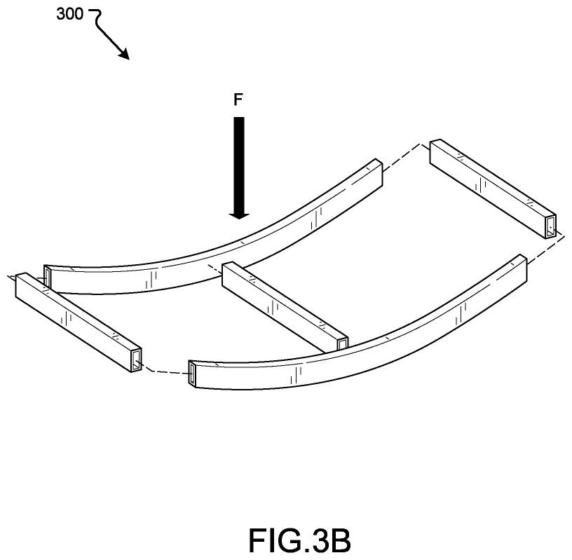

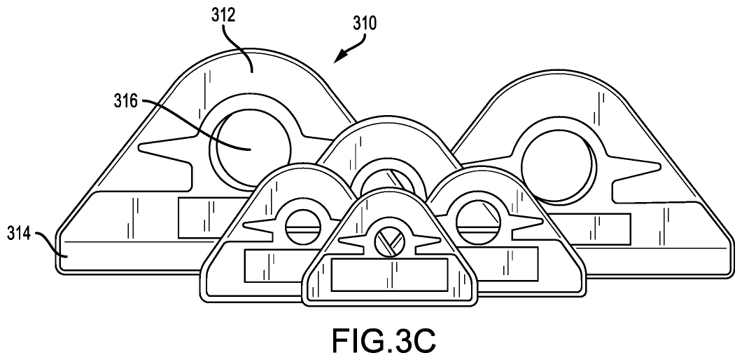

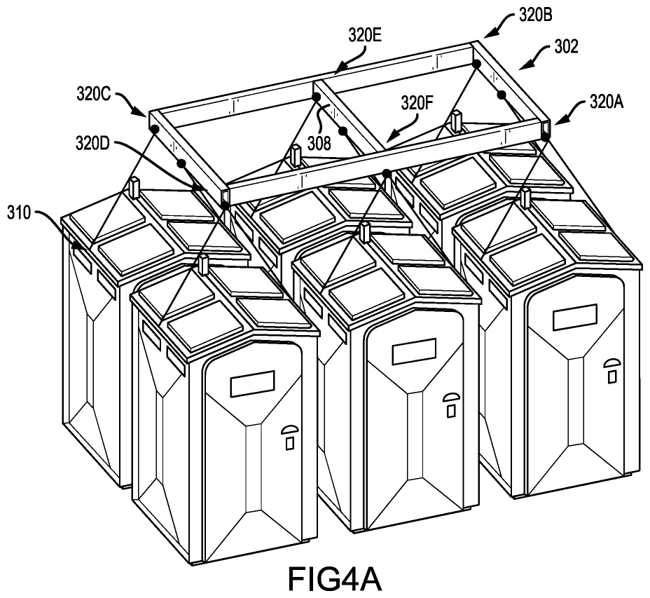

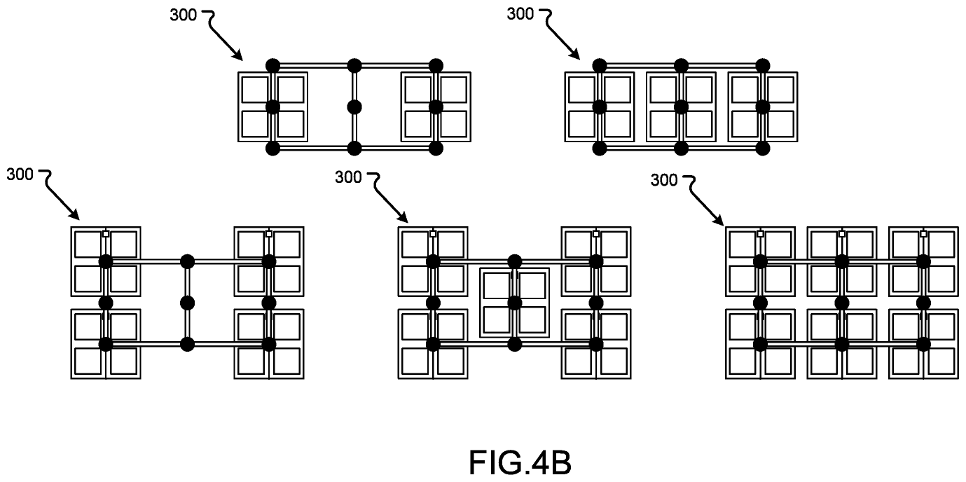

FIG. 3A illustrates a spreader bar lifting system 300 including a frame 302 having a plurality of beams. In various embodiments, the frame 302 has two lateral beams 304 extending along the lateral dimension, two longitudinal beams 306 extending between the two lateral beams in a longitudinal dimension, and one supporting beam 308 extending between the two longitudinal beams 306 and spaced approximately equally from the two lateral beams 304. It is appreciated that the number and orientation of the beams may vary in different embodiments. In various embodiments, the longitudinal and lateral beams 306 and 304 further define corners 320 (as shown in FIG. 4A) of the frame 302. In various embodiments, a spreader bar system 300 has a total self-weight of approximately 550 lbs. In other embodiments, the self-weight of the spreader bar may vary.

FIG. 3B provides an exploded view of the spreader bar lifting system 300, where a frame (not to scale) is shown as being deformed due to load bearing, generating a downward force F. In the non-limiting embodiment, the spreader bar system 300 has a deflection at 0.08 inches per inch of length when the total loaded weight is approximately 1000 lbs.

FIG. 3C illustrates a plurality of lifting attachments 310 operable to attached the lifting object to the spreader bar system 300, for example, to the corners 320 of the spreader bar system 300. In the non-limiting embodiment, the lifting attachments 310 are installed on top surfaces of the lifting objects, for example, portable toilets. The lifting attachment 310 are further spaced to match the structure of the frame and the arrangement of the lifting objects. When in operation, a suitable number of lifting attachments 310 are provided to match the number of the lifting objects. In the non-limiting embodiment, the lifting attachments 310 are pad-eyes, where each of the pad-eye has a maximum working load at 2,000 pounds. In some other embodiments, the maximum working load of the lifting attachment may vary. In various embodiments, each of the lifting attachments 310 are constructed in roughly triangle shape, including one bottom edge 314, a radius top 312, and a circular slot 316 constructed to receive a securing mechanism. In other embodiments, the structure and shape of the lifting attachment may vary.

FIGS. 4A-4B illustrate the spreading bar lifting system 300 in operation lifting portable toilets. As shown in FIG. 4A, the lifting attachments 310 are installed on top surfaces of the lifting project, for example, portable toilets. In various embodiments, the lifting attachments 310 are spaced to substantially match the structure of the frame and/or according to the number of lifting objects. In various embodiments a system 300 comprises six lifting objects and the lifting attachments 310 are arranged to substantially the position of the four corners of the frame 302 and the two ends of the bearing member 308.

FIG. 4B shows various configurations of spreader bar lifting system 300 to lift various lifting objects according to one or more embodiments of the present disclosure. For example, in some embodiments the lifting system 300 is suitable to lift 2-6 lifting objects as illustrated. Moreover, in various embodiments when there are two lifting objects, the two lifting objects are arranged to roughly align with the two short sidebars. In one or more embodiments, when there are three lifting objects, the two lifting objects are arranged to roughly align with the two sidebars and the bearing member. In one or more embodiments, when there are four lifting objects, the four lifting objects will be arranged to align with the four corners of a frame. In various embodiments, when there are five lifting objects, the five lifting objects are arranged to roughly align with four corner of the frame and the bearing member. However, the lifting configurations are not limiting as other configurations are also possible according to specific shapes, sizes, and weights of different lifting objects. Furthermore, the lifting system is also capable of lifting only one or more than 6 lifting objects so long as the total weight of the lifting objects does not exceed the maximum bearing weight of the lifting system and/or so long as the lifting system's arrangement provides a substantially balanced weight distribution.

Additionally, various features/components of one embodiment may be combined with features/components of another embodiment. For example, features/components of one figure can be combined with features/components of another figure or features/components of multiple figures. To avoid repetition, every different combination of features has not been described herein, but the different combinations are within the scope of this disclosure. Additionally, if details (including angles, dimensions, etc.) about a feature or component are described with one embodiment or one figure, then those details can apply to similar features of components in other embodiments or other figures.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. It is to be understood that the phraseology and terminology used herein is for the purpose of description and should not be regarded as limiting.

It is to be appreciated that any feature described herein can be claimed in combination with any other feature(s) as described herein, regardless of whether the features come from the same described embodiment.

What is claimed is:

1. A lifting device, comprising:
a frame;
a lifting platform pivotally connected to the frame, the lifting platform comprising at least one sidebar with a cavity; and
a supporting member operable to be provided in a diagonal orientation relative to the lifting platform and to the frame, the supporting member being operable to at least partially enable a predetermined angular position of the lifting platform relative to the frame, and the supporting member interconnecting the lifting platform and the frame;
wherein the lifting platform extends perpendicular to the frame when the lifting device is in an expanded state, and wherein the lifting platform is parallel to the frame when the lifting apparatus is in a folded state; and
wherein the supporting member and the frame are at least partially concealed within the cavity of the sidebar of the lifting platform when the lifting device is in the folded state.

2. The lifting device of claim 1, wherein the lifting platform comprises a first lifting platform and a second lifting platform that is opposite to the first lifting platform in a lateral dimension.

3. The lifting device of claim 1, wherein the supporting member comprises:
a length extending between a first end and a second end;
wherein the first end is pivotally connected to the frame;
wherein the supporting member is rotatable about the first end; and
wherein the second end is connected to the lifting platform in the expanded state, and wherein the second end is disconnected from the lifting platform in the folded state.

4. The lifting device of claim 1, wherein the supporting member comprises:
a length extending between a first end and a second end;
wherein the first end is pivotally connected to the frame;
wherein the supporting member is rotatable about the first end; and
wherein the first end is connected to the frame in the expanded state, and wherein the second end is disconnected from the frame in the folded state.

5. The lifting device of claim 1, wherein the supporting member comprises a first end and a second end, wherein the first end is removably attached to the frame and the second end is removably attached to the one of the lifting platform when in the expanded state.

6. The lifting device of claim 1, wherein the frame comprises:
an upper member;
a lower member being parallel to the upper member and spaced from the upper member in a vertical direction; and
at least one pillar being perpendicular to the upper and to the lower member in a vertical dimension, wherein the at least one pillar further comprises an exterior surface and at least one attachment mechanism on the exterior surface.

7. The lifting device of claim 1, wherein the predetermined angular position of the lifting platform is about 90 degrees relative to the lifting platform and the supporting member is substantially diagonal to the frame and one to the lifting platform when in the expanded state.

8. The lifting device of claim 1, wherein the at least one sidebar comprises a first sidebar and a second sidebar spaced from one another in a longitudinal dimension, wherein each of the first and second sidebars comprises a cavity configured to receive one of the supporting members when the lifting device is in the folded state.

9. A lifting system, comprising
a plurality of lifting devices each one comprising:
a frame comprising at least one attachment mechanism on an exterior surface of the frame;
one or more lifting platforms pivotally connected to the frame, wherein the one or more lifting platforms are perpendicular to the frame when the lifting apparatus is in an expanded state, and wherein the one or more lifting platforms are parallel to the frame when the lifting apparatus is in a folded state; and
one or more supporting members interconnecting the one or more lifting platforms and the frame,
wherein each of the plurality of lifting devices is connected to an adjacent one of the plurality of lifting devices through the at least one attachment mechanisms;
wherein the one or more lifting platforms are positioned at an approximately equal height when the one or more lifting platforms are attached; and
wherein the one or more lifting platforms are spaced apart from lifting platforms of an adjacent lifting device of the plurality in a longitudinal dimension when the one or more lifting platforms are attached.

10. The lifting system of claim 9, wherein the one or more lifting platforms comprise a first lifting platform and a second lifting platform opposite to the first lifting platform in a lateral dimension.

11. The lifting system of claim 9, wherein each of the one or more supporting members comprises:
a length extending between a first end and a second end;
wherein the first end is pivotally connected to the frame;
wherein each of the one or more supporting members are rotatable about the first end; and
wherein the second end is connected to the lifting platform in the expanded state, and wherein the second end is disconnected from the lifting platform in the folded state.

12. The lifting system of claim 9, wherein the frame comprises:
an upper member;
a lower member being parallel to the upper member and spaced from the upper member in a vertical direction; and
at least one pillar being perpendicular to the upper and to the lower member in a vertical dimension, wherein the at least one pillar further comprises an exterior surface and at least one attachment mechanism on the exterior surface.

13. The lifting system of claim 9, wherein each of the one or more supporting members comprises:
a length extending between a first end and a second end;
wherein the first end is pivotally connected to the frame;
wherein the one or more supporting members are rotatable about the first end; and
wherein the first end is connected to the frame in the expanded state, and wherein the second end is disconnected from the frame in the folded state.

14. The lifting system of claim 9, wherein each of the one or more supporting members comprises a first end and a second end, wherein the first end is removably attached to the frame and the second end is removably attached to one of the one or more lifting platforms when the lifting apparatus is in the expanded state.

15. The lifting device of claim 9, wherein each of the one or more supporting members is diagonal to the frame and one of the lifting platforms when in the expanded state.

16. The lifting system of claim 9, wherein each of the lifting platforms comprises a first sidebar and a second sidebar spaced apart from one another in a longitudinal dimension, wherein each of the first sidebar and the second sidebar comprises a cavity configured to receive a corresponding one of the one or more supporting members when the lifting device is in the folded state.

17. A spreader bar lifting system for lifting a plurality of portable toilets, the spreader bar lifting system comprising:
a frame, comprising a plurality of beams; and
one or more attachment mechanisms, wherein each of the one or more attachment mechanisms is removably connected to one of the plurality of beams; and
wherein at least some of the plurality of portable toilets are attached to the frame via the one or more attachment mechanisms when the plurality of portable toilets are installed.

18. The spreader bar lifting system of claim 17, wherein the one or more attachment mechanisms are attached to top surfaces of the portal toilets when the spreader bar lifting system is assembled.

19. The spreader bar lifting system of claim 17, wherein the frame comprises two or more longitudinal beams and one or more lateral beams approximately perpendicular to the longitudinal beams.

20. The spread bar lifting system of claim 17, wherein the longitudinal beams and the lateral beams form corners of the frame, and wherein the one or more attachment mechanisms are placed at the corners of the frame.
